(19) United States
(12) Patent Application Publication
(10) Pub. No.: US 2023/0383156 A1
(43) Pub. Date: Nov. 30, 2023

(54) ONE-COMPONENT POLYURETHANE ADHESIVE

(71) Applicant: DDP SPECIALTY ELECTRONIC MATERIALS US, LLC, Wilmington, DE (US)

(72) Inventors: THOMAS CLARK, AUBURN HILLS, MI (US); STEVE ALLISON, AUBURN HILLS, MI (US); NIRANJAN MALVADKAR, AUBURN HILLS, MI (US); AARON ANTWI, AUBURN HILLS, MI (US); JEFFREY LEITCH, AUBURN HILLS, MI (US); HUIDE ZHU, AUBURN HILLS, MI (US); DANIEL P. SOPHIEA, AUBURN HILLS, MI (US); MICHELLE HENDERSON, AUBURN HILLS, MI (US); ANDREW KNEISEL, AUBURN HILLS, MI (US); GAVIN VOGEL, AUBURN HILLS, MI (US); GABRIELE TASSELLI, FREIENBACH (CH)

(21) Appl. No.: 18/031,477

(22) PCT Filed: Aug. 17, 2021
(86) PCT No.: PCT/US2021/046240

§ 371 Date: Apr. 12, 2023

Related U.S. Application Data
(60) Provisional application No. 63/091,877, filed on Oct. 14, 2020.

(51) Int. Cl. C09J 175/04; C09J 4/00; C09J 11/04; C09J 11/06

(52) U.S. Cl. CPC C09J 175/04; C09J 4/00; C09J 11/04; C09J 11/06; C09J 2301/414; C09J 2301/312

(57) ABSTRACT

Provided herein is a one-component polyurethane adhesive composition showing excellent adhesive strength on glass surfaces.

### FIELD OF INVENTION

The present invention relates to the field of one-component polyurethane adhesives, particularly polyurethane adhesives for adhesion to glass.

### BACKGROUND OF THE INVENTION

One part polyurethane adhesives are used extensively in the automotive industry, particularly to facilitate rapid windshield repair. Commercial adhesives are designed to offer high modulus (>4.0 MPa Young's Modulus) to provide good vehicle stiffness and smooth ride. To satisfy consumer requirements, adhesives have been designed to allow the customer to safely drive the vehicle within 30 minutes of adhesive application (MDAT, minimum drive away time). However, such adhesives require primers on the glass frit of the replacement windshield in order to generate good adhesive strength (lap shear values >350 psi). Adhesives that provide primerless adhesion to the glass frit have been reported, but these adhesives lack the desirable high modulus and 30 minute MDAT.

There exists a need for one-component polyurethane adhesives for windshield repair that offer high modulus, good primerless adhesion and a MDAT of 30 minutes or less.

### SUMMARY OF THE INVENTION

In a first aspect, the invention provides a one-component polyurethane adhesive composition comprising:
(A) at least one polyether prepolymer at a total content of polyether prepolymer of 50-57 wt %;
(B) at least one polyester prepolymer at a total content of polyester prepolymer of 1.2-2.0 wt %;
(C) at least one aliphatic polyisocyanate at a total aliphatic polyisocyanate content of 0.4-1.2 wt %;
(D) at least one aromatic polyisocyanate at a total aromatic polyisocyanate content of 0.4-1.2 wt %;
(E) at least one isocyanate functionalized silane at a total isocyanate functionalized silane content of 0.4-1.5 wt %;
(F) amine catalyst at 0.50-0.99 wt %;
(G) at least one mercaptosilane at a total mercaptosilane content of <1.2 wt % and/or (G′) at least one aminosilane at a total aminosilane content of <0.5 wt % wherein the combination of amino and/or mercaptosilane is at least 0.6 wt %;
(H) carbon black at 17-20 wt %;
(I) calcium carbonate at 3-30 wt %;
(J) optionally filler, other than calcium carbonate and/or carbon black, at 0-27 wt %;
wherein the total polyisocyanate content is 1.2 to 3 wt %, the total of calcium carbonate plus filler is 20-30 wt %, and the weight percentages are based on the total weight of the polyurethane adhesive.

In a second aspect, the invention provides an adhered assembly comprising:
a glass substrate;
a second substrate;
a layer of an adhesive composition of the invention being adhesively in contact with both substrates.

In a third aspect, the invention provides a method for adhering a glass substrate to a second substrate, the method comprising the steps:
(1) providing a glass substrate and a second substrate;
(2) applying an adhesive composition of the invention to the glass substrate, the second substrate or both;
(3) assembling the glass substrate and the second substrate such that the adhesive is in adhesive contact with both substrates.

### DETAILED DESCRIPTION OF THE INVENTION

The inventors have surprisingly found that an adhesive composition according to claim 1 satisfies the requirements for a thirty-minute drive away time, that is:
impact strength after 30 minutes >3.4 J;
Young's modulus >4 MPa;
Lap shear strength on fritted glass >350 psi and >80% cohesive failure after 3 days at 23° C. and 50% RH;
Preferably electrically resistivity of >1×10⁸ ohm*cm

### Definitions and Abbreviations

MDI 4,4′-Methylenebis(phenyl isocyanate)
HDI Hexamethylene diisocyanate
PU polyurethane

Molecular weights of polymers as reported herein are reported in Daltons (Da) as number or weight average molecular weights, as determined by size exclusion chromatography (SEC).

The one-component polyurethane adhesive compositions of the invention comprise:
(A) at least one polyether prepolymer at a total content of polyether prepolymer of 50-57 wt %;
(B) at least one polyester prepolymer at a total content of polyester prepolymer of 1.2-2.0 wt %;
(C) at least one aliphatic polyisocyanate at a total aliphatic polyisocyanate content of 0.4-1.2 wt %;
(D) at least one aromatic polyisocyanate at a total aromatic polyisocyanate content of 0.4-1.2 wt %;
(E) at least one isocyanate functionalized silane at a total isocyanate functionalized silane content of 0.4-1.5 wt %;
(F) amine catalyst at 0.50-0.99 wt %;
(G) at least one mercaptosilane at a total mercaptosilane content of <1.2 wt % and/or (G′) at least one aminosilane at a total aminosilane content of <0.5 wt % wherein the combination of amino and/or mercaptosilane is at least 0.6 wt %;
(H) carbon black at 17-20 wt %;
(I) calcium carbonate at 3-30 wt %;
(J) optionally filler, other than calcium carbonate and/or carbon black, at 0-27 wt %;
wherein the total polyisocyanate content is 1.2 to 3 wt %, the total of calcium carbonate plus filler is 20-30 wt %, and the weight percentages are based on the total weight of the polyurethane adhesive.

Polyether Prepolymer (A)

The inventive compositions comprise a polyether prepolymer at 50-57 wt %, based on the total weight of the composition.

Polyether prepolymers include polymers that are made by polymerizing one or more polyether polyols in the presence of a polyisocyanate, preferable diisocyanate. Polyether polyols useful in the invention include for example, polyether polyols, poly(alkylene carbonate)polyols, hydroxyl containing polythioethers, polymer polyols, and mixtures thereof. Polyether polyols are well-known in the art and include, for example, polyoxyethylene, polyoxypropylene, polyoxybutylene, and polytetramethylene ether diols and triols which are prepared by reacting an unsubstituted or halogen- or aromatic-substituted ethylene oxide or propylene oxide with an initiator compound containing two or more active hydrogen groups such as water, ammonia, a polyalcohol, or an amine. In general, polyether polyols may be prepared by polymerizing alkylene oxides in the presence of an active hydrogen-containing initiator compound. Preferred polyether polyols contain one or more alkylene oxide units in the backbone of the polyol. Preferred alkylene oxide units are ethylene oxide, propylene oxide, butylene oxide and mixtures thereof. Preferably, the polyol contains propylene oxide units, ethylene oxide units or a mixture thereof. In the embodiment where a mixture of alkylene oxide units is contained in a polyol, the different units can be randomly arranged or can be arranged in blocks of each alkylene oxides. In one preferred embodiment, the polyol comprises propylene oxide chains with ethylene oxide chains capping the polyol. In a preferred embodiment, the polyether polyols are a mixture of polyether diols and polyether triols. Preferably, the polyether polyol or mixture has a functionality of at least about 1.5, more preferably at least about 1.8, and is most preferably at least about 2.0; and is preferably no greater than about 4.0, more preferably no greater than about 3.5, and is most preferably no greater than about 3.0. Preferably, the equivalent weight of the polyether polyol mixture is at least about 200, more preferably at least about 500, and is more preferably at least about 1,000; and is preferably no greater than about 5,000, more preferably no greater than about 3,000, and is most preferably no greater than about 2,500.

More specific examples include:

1. Difunctional polyols (diols), such as poly(alkylene oxide)diols, where the alkylene group is C₂ to C₄, particularly poly(ethylene oxide)diol, poly(propylene oxide)diol and poly(tetramethylene oxide)diol, with poly(propylene oxide)diol being particularly preferred. In a particularly preferred embodiment the polyether prepolymer comprises a nominally difunctional, poly(propylene oxide) having a hydroxyl number of 56 (equivalent weight 1000);

2. Trifunctional polyols (triols), such as those based on the alkylene oxides initiated with a trifunctional polyol, such as trimethylolpropane, where the alkylene group is C₂ to C₄, particularly ethylene oxide, propylene oxide and butylene oxide, with propylene oxide being particularly preferred. In a particularly preferred embodiment, the polyether prepolymer comprises a nominally trifunctional poly(propylene oxide) having a hydroxyl number of 36 (equivalent weight 1558); the polymer may or may not be capped with ethylene oxide to modify reactivity

3. A mixture of 1 and 2. Particularly preferred is a mixture of 1 and 2, more particularly preferred is a mixture of a) a nominally difunctional, poly(propylene oxide) having a hydroxyl number of 56 (equivalent weight 1000) and b) a nominally trifunctional poly(propylene oxide) having a hydroxyl number of 36 (equivalent weight 1558), particularly at a weight ratio b)/a) of 1:2 to 2:1.

The diisocyanate that may be used to make the polyether prepolymer is not particularly limited. Aliphatic and aromatic diisocyanates may be used. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), and isophorone diisocyanate (IPDI), with MDI being particularly preferred.

In a particularly preferred embodiment, the polyether prepolymer comprises a nominally trifunctional poly(propylene oxide) having a hydroxyl number of 36 (equivalent weight 1558) and a nominally trifunctional poly(propylene oxide) having a hydroxyl number of 56 (equivalent weight 1000), reacted with MDI.

In a preferred embodiment, the polyether prepolymer has an isocyanate content of 1.25% by weight, and a viscosity of 16,000 cps at 23° C. as measured according to the procedure described in U.S. Pat. No. 5,922,809 at column 12, lines 38 to 49.

The polyether prepolymer is present at 50-57 wt %, based on the total weight of the adhesive composition, more preferably 51-54 wt %, more particularly preferably 52-54 wt %.

In a particularly preferred embodiment, the adhesive composition of the invention comprises 52-54 wt % of a polyether prepolymer %, based on the total weight of the adhesive composition, comprising a nominally trifunctional poly(propylene oxide) having a hydroxyl number of 36 (equivalent weight 1558) and a nominally trifunctional poly(propylene oxide) having a hydroxyl number of 56 (equivalent weight 1000), reacted with MDI, and having an isocyanate content of 1.25% by weight, and a viscosity of 16,000 cps at 23° C. as measured according to the procedure described in U.S. Pat. No. 5,922,809 at column 12, lines 38 to 49.

Polyester Prepolymer (B)

The inventive adhesive compositions comprise a polyester prepolymer at 1.2-2.0 wt %, based on the total weight of the composition.

Polyester polyols include polymers that are made by reacting one or more linear copolyesters with primary hydroxyl functionality with a polyisocyanate, preferably a diisocyanate. Particularly preferred are copolyesters having molecular weight of 3,000-4,000 Da, preferably 3,500 Da.

The diisocyanate that may be used to make the polyester prepolymer is not particularly limited. Aliphatic and aromatic diisocyanates may be used. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), and isophorone diisocyanate (IPDI), with MDI being particularly preferred.

In a preferred embodiment, the polyester prepolymer is made by reacting a copolyester of molecular weight of 3,500 Da with MDI. Preferably it has a melting point of 45-90° C.

The polyester prepolymer is present at 1.2-2.0 wt %, based on the total weight of the composition, preferably at 1.25-1.55 wt %, more preferably 1.3 to 1.5 wt %, based on the total weight of the adhesive composition.

Aliphatic Polyisocyanate (C)

The adhesive compositions of the invention comprise at least one aliphatic polyisocyanate at a total aliphatic polyisocyanate content of 0.4-1.2 wt %.

The aliphatic polyisocyanate is not particularly limited. Some examples include isophorone diisocyanate, 1,6-hexamethylene diisocyanate, bis(4-isocyanatocyclohexyl)methane, and trimethyl hexamethylene diisocyanate, any of which can be modified to include biuret, allophonate, urea, carbamate, isocyanurate or carbodiimide groups.

In a preferred embodiment, the aliphatic polyisocyanate is based on HDI trimer having an NCO content of 21.8±0.3% (according to DIN EN ISO 11 909).

The aliphatic polyisocyanate is present in the adhesive compositions of the invention at 0.4-1.2 wt %, based on the total weight of the composition, preferably at 0.45 to 1 wt %, more preferably 0.5 to 1 wt %.

In a particularly preferred embodiment, the aliphatic polyisocyanate is HDI trimer having an NCO content of 21.8±0.3% (according to DIN EN ISO 11 909) at 0.5 to 1 wt %, based on the total weight of the adhesive composition.

Aromatic Polyisocyanate (D)

The adhesive compositions of the invention comprise (D) at least one aromatic polyisocyanate at a total aromatic polyisocyanate content of 0.4-1.2 wt %, based on the total weight of the adhesive composition.

The aromatic polyisocyanate is not particularly limited. Examples include diphenylmethane diisocyanate (MDI), polymethylene polyphenylisocyanates, polymeric MDI (PMDI, a mixture of diphenylmethane diisocyanate and polymethylene polyphenylioscyanates), tetramethylxylene diisocyanate, toluene diisocyanate, any of which can be modified to include biuret, allophonate, urea, carbamate, isocyanurate or carbodiimide groups.

In a preferred embodiment, the aromatic polyisocyanate is polymethylene polyphenylisocyanate that contains MDI, having an NCO content of 30.4% (according to DIN EN ISO 11 909).

The aromatic polyisocyanate is used at 0.4 to 1.2 wt %, based on the total weight of the adhesive composition, preferably at 0.5 to 1 wt %, more preferably at 0.75 wt %.

In a particularly preferred embodiment the aromatic polyisocyanate is polymethylene polyphenylisocyanate that contains MDI, having an NCO content of 30.4% (according to DIN EN ISO 11 909) at 0.5 to 1 wt %, more preferably 0.75 wt %, based on the total weight of the adhesive composition.

Isocyanate Functionalized Silane (E)

The adhesive compositions of the invention comprise (E) at least one isocyanate functionalized silane at a total isocyanate functionalized silane content of 0.4-1.5 wt %, based on the total weight of the adhesive composition.

The isocyanate functionalized silane is not particularly limited. Examples include those made by reacting a polyisocyanate compound, such as toluenediisocyanate, methylenediphenyl diisocyanate, with a polyalkyleneoxide having terminal hydroxyl groups to produce polyalkyleneoxide having terminal isocyanate groups, which are subsequently reacted with an active hydrogen-containing group W of a silicone compound of the formula:

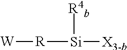

wherein W is an active hydrogen-containing group selected from the group consisting of a hydroxyl group, a carboxyl group, a mercapto group, a primary amino group and a secondary amino group, X is hydrolysable alkoxy group, and R⁴ is a C₁-C₂₀ alkyl, a C₆-C₂₀ aryl, a C₁-C₂₀ aralkyl group, R is selected from C₁-C₂₀ hydrocarbon groups, particularly a methylene or propylene group, and b is 0, 1 or 2.

More examples include:
reaction products of aminosilanes with polyisocyanates;
reaction products of mercaptosilanes with polyisocyanates;
reaction products of carboxylate functionalized silanes with polyisocyanates;
isocyanate functionalized silanes such as (3-isocyanatopropyl)trimethoxysilane.

Particularly preferred are reaction products of aminosilanes with polyisocyanates, more particularly secondary amine aminosilanes.

In a preferred embodiment, the isocyanate functionalised silane is a reaction product of a secondary aminoalkoxy silane and a polyisocyanate, for example a reaction product of N,N-bis[(3-trimethoxysilyl)-propyl]amine) reacted with HDI-Biuret.

In a particularly preferred embodiment, the isocyanate functionalised silane is a reaction product of N,N-bis[(3-trimethoxysilyl)-propyl]amine) reacted with HDI-Biuret, having an isocyanate content of 7%. The isocyanate functionalized silane may contain additional inert additives such as plasticizers

The isocyanate functionalised silane is present at 0.4-1.5 wt %, based on the total weight of the adhesive composition, preferably at 0.6 to 1.2 wt %, more preferably at 0.85-0.97 wt %.

In a particularly preferred embodiment, the isocyanate functionalised silane is a reaction product of N,N-bis[(3-trimethoxysilyl)-propyl]amine) reacted with HDI-Biuret, having an isocyanate content of 7% at 0.8-1.0 wt %, preferably 0.85-0.97 wt %, based on the total weight of the adhesive composition.

Amine Catalyst (F)

The adhesive compositions of the invention comprise (F) an amine catalyst at 0.50-0.99 wt %, based on the total weight of the adhesive composition.

The amine catalyst is any amine catalyst capable of catalysing the reaction of an isocyanate with moisture. Preferred are tertiary amines, for example aliphatic cyclic and non-cyclic tertiary amines, such as N,N-dimethylcyclohexane, triethylenediamine, N,N,N,N-tetramethylalkylenediamine, N,N,N,N-pentamethyldiethylenetriamine, triethylamine, N,N-dimethylbenzylamine, N,N-dimethylhexadecylamine, N,N-dimethylbutylamine, 2,2′-dimorpholinodiethyl ether.

Particularly preferred is 2,2′-dimorpholinodiethyl ether.

The amine catalyst is used at 0.5-0.99 wt %, based on the total weight of the adhesive composition, preferably at 0.6 to 0.8 wt %, more preferably at 0.75 wt %.

In a preferred embodiment, the amine catalyst is 2,2′-dimorpholinodiethyl ether at 0.75 wt %, based on the total weight of the adhesive composition.

The adhesive compositions of the invention may additionally contain a tin catalyst, a zinc catalyst (e.g. zinc carboxylates), bismuth catalysts, and mixtures of these.

Mercaptosilane (G)

The adhesive compositions of the invention comprise (G) at least one mercaptosilane at <1.2 wt % and/or (G′) at least one aminosilane at <0.5 wt % wherein the combination of amino and/or mercaptosilane is at least 0.6 wt %, based on the total weight of the adhesive composition.

The mercaptosilane is not particularly limited. Particularly preferred are mercaptosilanes of the following formula:

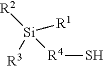

where R¹, R² and R³ are independently selected from OCH₃ and OC₂H₅; and R⁴ is CₙH₂ₙ where n is an integer of 1 to 12.

Particularly preferred are mercaptosilanes in which R¹, R² and R³ are OCH₃ and n is 1 to 6.

In a preferred embodiment the mercaptosilane is gamma-mercaptopropyltrimethoxysilane.

The at least one mercaptosilane is preferably present at a total mercaptosilane content of <1.2 wt %, based on the total weight of the adhesive composition, more preferably at 0.9 to 1 wt %, particularly preferably at 0.91 to 0.95 wt %.

In a particularly preferred embodiment, the at least one mercaptosilane is gamma-mercaptopropyltrimethoxysilane at 0.93, 0.94 or 0.95 wt %, based on the total weight of the adhesive composition.

Aminosilane (G′)

The adhesive compositions of the invention comprise (G) at least one mercaptosilane at <1.2 wt % and/or (G′) at least one aminosilane at <0.5 wt % wherein the combination of amino and/or mercaptosilane is at least 0.6 wt %, based on the total weight of the adhesive composition.

The aminosilane is not particularly limited. Primary and secondary aminosilanes may be used. Particularly preferred are silanes comprising secondary amines, in particular aminosilanes of the following formula:

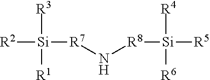

where R¹, R², R³, R⁴, R⁵ and R⁶ are independently selected from OCH₃ and OC₂H₅;

and R⁷ and R⁸ are independently selected from CₙH₂ₙ where n is an integer of 1 to 6, preferably n is 3.

In a preferred embodiment, the at least one aminosilane is bis(gamma-trimethoxysilylpropyl)amine.

The at least one aminosilane is preferably present at a total aminosilane content of <0.5 wt %, based on the total weight of the adhesive composition, more preferably <0.15 wt %, for example 0.05 or 0.11 wt %.

In a particularly preferred embodiment, the at least one aminosilane is bis(gamma-trimethoxysilylpropyl)amine at 0.11 wt %, based on the total weight of the adhesive composition.

Carbon Black (H)

The adhesive compositions of the invention comprise (H) carbon black at 17-20 wt %, based on the total weight of the adhesive composition.

The carbon black is not particularly limited. Preferred carbon blacks exhibit an oil absorption number of at least 80, preferably at least 90 and more preferably at least 95 cm³ of dibutyl phthalate per 100 g of carbon black, as measured according to ASTM D-2414-09. In addition the carbon black desirably has an iodine number of at least 80, determined according to ASTM D1510-11.

The carbon black is present at 17-20 wt %, based on the total weight of the adhesive composition, preferably at 17.6 to 18 wt %.

Calcium Carbonate (I)

The adhesive compositions of the invention comprise (I) calcium carbonate at 3-30 wt %, based on the total weight of the adhesive composition.

Preferably the calcium carbonate is present at 6 to 10 wt %, more preferably at 7 to 8 wt %, based on the total weight of the adhesive composition.

The total content of calcium carbonate plus filler is 20-30 wt %, based on the total weigh of the composition.

Filler (J)

The adhesive compositions of the invention optionally comprise additional filler at 0-27 wt %, other than calcium carbonate and/or carbon black, based on the total weight of the composition.

Examples of suitable fillers include clays, zeolites and silicates.

The filler may be clay, which may be present at 0-27 wt %. The clay is not particularly limited. Preferably the clay is in the form of pulverized powder, spray dried beads or finely ground particles. Surface treated aluminum silicates are an example. Calcined aluminium silicate clays (Kaolin) are preferred.

The total content of calcium carbonate plus filler, for example clay, is 20-30 wt %, based on the total weigh of the composition.

In a preferred embodiment, the adhesive composition of the invention comprises 20 to 25 wt % clay, more preferably 21 to 24 wt %, particularly preferably 22 to 23 wt %, based on the total weight of the adhesive composition.

Other Ingredients

The adhesive compositions of the invention may additionally comprise other ingredients, such as, for example, one or more plasticizers (such as diisononyl phthalate), one or more stabilizers for example heat, light and UV-stabilizers.

Examples of heat stabilizers include alkyl substituted phenols, phosphites, sebacates and cinnamates. If present, a preferred heat stabilizer is an organophosphite and more specifically trisnonylphenyl phosphite as disclosed in U.S. Pat. No. 6,512,033, incorporated herein by reference. The heat stabilizer may constitute at least 0.01 or at least 0.3 weight percent based on the entire weight of the adhesive composition, up to at most 5 weight percent, up to 2 weight percent or up to 1.0 weight percent. The adhesive composition may be devoid of such a heat stabilizer.

For UV light stabilizers, they include benzophenones and benzotriazoles. Specific UV light absorbers include those from BASF such as TINUVIN™ P TINUVIN™ 326, TINUVIN™ 213, TINUVIN™ 327, TINUVIN™ 571, TINUVIN™ 328, and from Cytec such as CYASORB™ UV-9, CYASORB™ UV-24, CYASORB™ UV-1164, CYASORB™ UV-2337, CYASORB™ UV-2908, CYASORB™ UV-5337, CYASORB™ UV-531, and CYASORB™ UV-3638. Among these, TINUVIN™ 571 is preferred. One or more UV light absorbers may constitute at least 0.1 weight percent, at least 0.2 weight percent or at least 0.3 parts by weight of the weight of the adhesive composition, and may constitute up to 3 weight percent, up to 2 weight percent or up to 1 weight percent thereof.

The adhesive composition of the invention may further include one or more light stabilizers. Preferred light stabilizers included hindered amine light stabilizers such as TINUVIN™ 144, TINUVIN™ 622, TINUVIN™ 77, TINUVIN™ 123, TINUVIN™ 765, CHIMASSORB™ 944 available from Cytec; CYASORB™ UV-500, CYASORB™ UV-3581, CYASORB™ UV-3346, all available from Ciba-Geigy. Among these, TINUVIN™ 765 is preferred choice. The light stabilizer(s) may constitute at least 0.1 weight percent, at least 0.2 weight percent or at least 0.3 weight percent of the adhesive composition, and may constitute up to 3 weight percent, up to 2 weight percent or up to 1.5 weight percent thereof.

Adhered Assemblies

In one aspect, the invention provides an adhered assembly comprising:
a glass substrate;
a second substrate;
a layer of an adhesive composition of the invention being adhesively in contact with both substrates.

The second substrate is not particularly limited, and may be, for example, glass, metal (particularly primed metal), e-coated surfaces, painted surfaces, wood, and cured polyurethanes. In a preferred embodiment, the second substrate is selected from metal (particularly primed metal), e-coated surface, cured polyurethanes and cured silanated polyurethanes.

The adhesives of the invention are particularly suited for adhering a windshield to an automobile chassis, particularly in after-market use. Typically a damaged windshield is removed from the chassis, leaving behind the original, cured adhesive, which is cut or trimmed to avoid excess. The adhesive of the invention is applied to the cut cured adhesive (usually a PU-based adhesive but may also be a silanated PU). Because the adhesives of the invention achieve impact strengths after 30 minutes >3.4 J (as well as other requirements), they permit a 30-minute drive away time.

In a particularly preferred embodiment, the assembly of the invention comprises:
a glass substrate;
a cured adhesive substrate (such as cured polyurethane or cured silanated polyurethane);
a layer of an adhesive composition of the invention being adhesively in contact with both substrates.

Method of Manufacture

The adhesive compositions of the invention are made by mixing the ingredients under inert and dry conditions and/or under vacuum, until a homogenous mixture is obtained.

In one preferred method of manufacture, the calcium carbonate, filler (if used), and carbon black are mixed and dried at elevated temperature (e.g. at or about 204° C.) for a prolonged period (e.g. at or about 20 hours) and then cooled in a closed container to form a filler mixture. The polyester prepolymer may be heated to 80° C. for about 15 h prior to use. The polyether prepolymer, amine catalyst, aliphatic polyisocyanate, optional plasticizer (e.g. diisononyl phthalate), and isocyanate functionalized silane are charged into a mixer. The mixture may be degassed and mixed under vacuum. The vacuum is broken with nitrogen and the mercaptosilane and aminosilane are added, followed by additional degassing and mixing under vacuum. The vacuum is broken again with nitrogen and the filler mixture is added into the mixer. Mixing is carried out to wet out the fillers. Vacuum is applied and mixing continued. After breaking the vacuum with nitrogen, the mixture is scraped down and the polyester prepolymer is added along with any stabilizers. Mixing under vacuum is continued. The resulting adhesive composition may be packaged, for example, it may be packaged into airtight tubes which are stored in nitrogen filled sealed aluminium bags.

Use

The adhesive compositions of the invention are particularly suited for adhering glass to a second substrate. In particular, they are designed to satisfy the requirements for a thirty-minute drive away time, that is:
impact strength after 30 minutes >3.4 J;
Young's modulus >4 MPa;
Lap shear strength on AD3402 >350 psi and >80% cohesive failure after 3 days at 23° C. and 50% RH;
Preferably electrically resistivity of >1×10⁸ ohm*cm

In use, the adhesives are applied to a glass substrate and/or to the second substrate. If necessary, for example if the second substrate is a metal, the second substrate may be cleaned and primed prior to applying the adhesive. Typically for after-market windshield replacement, the second substrate is substantially the cured adhesive (usually PU or silanated PU) that was previously holding the windshield in place. The glass substrate and the second substrate are then brought into adhesive contact with each other, with the adhesive of the invention sandwiched therebetween. The adhesives of the invention give good results without the use of a primer. This is desirable as the application of a primer involves an additional step as well as drying time.

Curing is effected by atmospheric moisture.

### Particularly Preferred Embodiments

The following are particularly preferred embodiments of the adhesive compositions of the invention:
An adhesive composition comprising:
(A) at least one polyether prepolymer at a total content of polyether prepolymer of 52-54 wt %;
(B) at least one polyester prepolymer at a total content of polyester prepolymer of 1.3-1.5 wt %;
(C) at least one aliphatic polyisocyanate at a total aliphatic polyisocyanate content of 0.5-1 wt %;
(D) at least one aromatic polyisocyanate at a total aromatic polyisocyanate content of 0.5-1 wt %;
(E) at least one isocyanate functionalized silane at a total isocyanate functionalized silane content of 0.6-1.2 wt %;
(F) amine catalyst at 0.6-0.8 wt %;
(G) at least one mercaptosilane at a total mercaptosilane content of 0.9 to 1 wt % and/or (G′) at least one aminosilane at a total aminosilane content of 0.03-0.15 wt % wherein the combination of amino and/or mercaptosilane is at least 0.6 wt %;
(H) carbon black at 17.6-18 wt %;
(I) calcium carbonate at 7-8 wt %;
(J) clay at 21-24 wt %;
wherein the total polyisocyanate content is 1.2 to 3 wt %, the total of calcium carbonate plus clay is 20-30 wt %, and the weight percentages are based on the total weight of the polyurethane adhesive.
An adhesive composition comprising:
(A) at least one polyether prepolymer made by polymerizing one or more polyols in the presence of a polyisocyanate, preferable diisocyanate, the polyether polyol may be selected from polyether polyols, hydroxyl containing polythioethers, polymer polyols, and mixtures thereof. Polyether polyols are well-known in the art and include, for example, polyoxyethylene, polyoxypropylene, polyoxybutylene, and polytetramethylene ether diols and triols which are prepared by reacting an unsubstituted or halogen- or aromatic-substituted ethylene oxide or propylene oxide with an initiator compound containing two or more active hydrogen groups such as water, ammonia, a polyalcohol, or an amine. In general, polyether polyols may be prepared by polymerizing alkylene oxides in the presence of an active hydrogen-containing initiator compound.
(B) at least one polyester prepolymer made by reacting one or more linear copolyesters with primary hydroxyl functionality with a polyisocyanate, preferably a diisocyanate, at a total content of polyester prepolymer of 1.2-2.0 wt %;
(C) at least one aliphatic polyisocyanate selected from isophorone diisocyanate, 1,6-hexamethylene diisocyanate, bis(4-isocyanatocyclohexyl)methane, and trimethyl hexamethylene diisocyanate, any of which can be modified to include biuret, allophonate, urea, carbamate, isocyanurate or carbodiimide groups, at a total aliphatic polyisocyanate content of 0.4-1.2 wt %;
(D) at least one aromatic polyisocyanate selected from diphenylmethane diisocyanate (MDI), polymethylene polyphenylisocyanates, polymeric MDI (PMDI, a mixture of diphenylmethane diisocyanate and polymethylene polyphenylioscyanates), tetramethylxylene diisocyanate, toluene diisocyanate, any of which can be modified to include biuret, allophonate, urea, carbamate, isocyanurate or carbodiimide groups, at a total aromatic polyisocyanate content of 0.4-1.2 wt %;
(E) at least one isocyanate functionalized silane selected from silanes made by reacting a polyisocyanate compound, such as toluenediisocyanate, methylenediphenyl diisocyanate, with a polyalkyleneoxide having terminal hydroxyl groups to produce polyalkyleneoxide having terminal isocyanate groups, which are subsequently reacted with an active hydrogen-containing group W of a silicone compound of the formula:

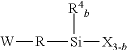

wherein W is an active hydrogen-containing group selected from the group consisting of a hydroxyl group, a carboxyl group, a mercapto group, a primary amino group and a secondary amino group, X is hydrolysable alkoxy group, and R⁴ is a C₁-C₂₀ alkyl, a C₆-C₂₀ aryl, a C₁-C₂₀ aralkyl group, R is selected from C₁-C₂₀ hydrocarbon groups, particularly a methylene or propylene group, and b is 0, 1 or 2. at a total isocyanate functionalized silane content of 0.4-1.5 wt %;
(F) a tertiary amine catalyst at 0.50-0.99 wt %;
(G) at least one mercaptosilane of the following formula:

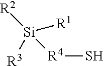

where R¹, R² and R³ are independently selected from OCH₃ and OC₂H₅;
and R⁴ is CₙH₂ₙ where n is an integer of 1 to 12, at a total mercaptosilane content of <1.2 wt % and/or (G′) at least one aminosilane of the following formula:

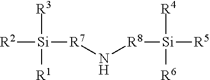

where R¹, R², R³, R⁴, R⁵ and R⁶ are independently selected from OCH₃ and OC₂H₅;
and R⁷ and R⁸ are independently selected from CₙH₂ₙ where n is an integer of 1 to 6, preferably n is 3, at a total aminosilane content of <0.5 wt % wherein the combination of amino and/or mercaptosilane is at least 0.6 wt %;
(H) carbon black at 17-20 wt %;
(I) calcium carbonate at 3-30 wt %;
(J) optionally clay at 0-27 wt %;
wherein the total polyisocyanate content is 1.2 to 3 wt %, the total of calcium carbonate plus clay is 20-30 wt %, and the weight percentages are based on the total weight of the polyurethane adhesive.
An adhesive composition comprising:
(A) at least one polyether prepolymer which is made by polymerizing one or more polyether polyols in the presence of a polyisocyanate, preferable diisocyanate, wherein the polyol is selected from polyether polyols, polyester polyols, poly(alkylene carbonate)polyols, hydroxyl containing polythioethers, polymer polyols, and mixtures thereof, at a total content of polyether prepolymer of 50-57 wt %;
(B) at least one polyester prepolymer made by reacting one or more linear copolyesters with primary hydroxyl functionality with a polyisocyanate, preferably a diisocyanate, at a total content of polyester prepolymer of 1.2-2.0 wt %;
(C) at least one aliphatic polyisocyanate selected from isophorone diisocyanate, 1,6-hexamethylene diisocyanate, bis(4-isocyanatocyclohexyl)methane, and trimethyl hexamethylene diisocyanate, any of which can be modified to include biuret, allophonate, urea, carbamate, isocyanurate or carbodiimide groups, at a total aliphatic polyisocyanate content of 0.4-1.2 wt %;
(D) at least one aromatic polyisocyanate selected from diphenylmethane diisocyanate (MDI), polymethylene polyphenylisocyanates, polymeric MDI (PMDI, a mixture of diphenylmethane diisocyanate and polymethylene polyphenylioscyanates), tetramethylxylene diisocyanate, toluene diisocyanate, any of which can be modified to include biuret, allophonate, urea, carbamate, isocyanurate or carbodiimide groups, at a total aromatic polyisocyanate content of 0.4-1.2 wt %;
(E) at least one isocyanate functionalized silane selected from silanes made by reacting a polyisocyanate compound, such as toluenediisocyanate, methylenediphenyl diisocyanate, with a polyalkyleneoxide having terminal hydroxyl groups to produce polyalkyleneoxide having terminal isocyanate groups, which are subsequently reacted with an active hydrogen-containing group W of a silicone compounds of the formula:

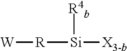

wherein W is an active hydrogen-containing group selected from the group consisting of a hydroxyl group, a carboxyl group, a mercapto group, a primary amino group and a secondary amino group, X is hydrolysable alkoxy group, and R⁴ is a C₁-C₂₀ alkyl, a C₆-C₂₀ aryl, a C₁-C₂₀ aralkyl group, R is selected from C₁-C₂₀ hydrocarbon groups, particularly a methylene or propylene group, and b is 0, 1 or 2. at a total isocyanate functionalized silane content of 0.4-1.5 wt %;
(F) a tertiary amine catalyst at 0.50-0.99 wt %;
(G) at least one mercaptosilane of the following formula:

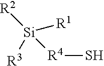

where R¹, R² and R³ are independently selected from OCH₃ and OC₂H₅; and R⁴ is CₙH₂ₙ where n is an integer of 1 to 12, at a total mercaptosilane content of <1.2 wt % and/or (G′) at least one aminosilane of the following formula:

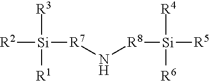

where R¹, R², R³, R⁴, R⁵ and R⁶ are independently selected from OCH₃ and OC₂H₅;
and R⁷ and R⁸ are independently selected from CₙH₂ₙ where n is an integer of 1 to 6, preferably n is 3, at a total aminosilane content of <0.5 wt % wherein the combination of amino and/or mercaptosilane is at least 0.6 wt %;
(H) carbon black at 17-20 wt %;
(I) calcium carbonate at 3-30 wt %;
(J) optionally clay at 0-27 wt %;
wherein the total polyisocyanate content is 1.2 to 3 wt %, the total of calcium carbonate plus clay is 20-30 wt %, and the weight percentages are based on the total weight of the polyurethane adhesive.
An adhesive composition comprising:
(A) at least one polyether prepolymer made by polymerizing one or more polyether polyols in the presence of a polyisocyanate, preferable diisocyanate, at a total content of polyether prepolymer of 50-57 wt %;
(B) at least one polyester prepolymer made by reacting one or more linear copolyesters with primary hydroxyl functionality with a polyisocyanate, preferably a diisocyanate, at a total content of polyester prepolymer of 1.2-2.0 wt %;
(C) at least one aliphatic polyisocyanate selected from isophorone diisocyanate, 1,6-hexamethylene diisocyanate, bis(4-isocyanatocyclohexyl)methane, and trimethyl hexamethylene diisocyanate, any of which can be modified to include biuret, allophonate, urea, carbamate, isocyanurate or carbodiimide groups, at a total aliphatic polyisocyanate content of 0.4-1.2 wt %;
(D) at least one aromatic polyisocyanate selected from diphenylmethane diisocyanate (MDI), polymethylene polyphenylisocyanates, polymeric MDI (PMDI, a mixture of diphenylmethane diisocyanate and polymethylene polyphenylioscyanates), tetramethylxylene diisocyanate, toluene diisocyanate, any of which can be modified to include biuret, allophonate, urea, carbamate, isocyanurate or carbodiimide groups, at a total aromatic polyisocyanate content of 0.4-1.2 wt %;
(E) at least one isocyanate functionalized silane that is a reaction product of an aminosilanes with a polyisocyanate or a reaction product of a mercaptosilane with a polyisocyanate, at a total isocyanate functionalized silane content of 0.4-1.5 wt %;
(F) a tertiary amine catalyst at 0.50-0.99 wt %;
(G) at least one mercaptosilane of the following formula:

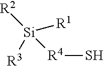

where R¹, R² and R³ are independently selected from OCH₃ and OC₂H₅;
and R⁴ is CₙH₂ₙ where n is an integer of 1 to 12, at a total mercaptosilane content of <1.2 wt % and/or (G′) at least one aminosilane of the following formula:

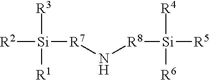

where R¹, R², R³, R⁴, R⁵ and R⁶ are independently selected from OCH₃ and OC₂H₅;
and R⁷ and R⁸ are independently selected from CₙH₂ₙ where n is an integer of 1 to 6, preferably n is 3,
at a total aminosilane content of <0.5 wt % wherein the combination of amino and/or mercaptosilane is at least 0.6 wt %;
(H) carbon black at 17-20 wt %;
(I) calcium carbonate at 3-30 wt %;
(J) optionally clay at 0-27 wt %;
wherein the total polyisocyanate content is 1.2 to 3 wt %, the total of calcium carbonate plus clay is 20-30 wt %, and the weight percentages are based on the total weight of the polyurethane adhesive.

An adhesive composition comprising:
(A) 50-57 wt % of a polyether prepolymer, based on the total weight of the adhesive composition, comprising a mixture of polyalkylene oxide diols and triols reacted with MDI, and having an isocyanate content of 1.25% by weight, and a viscosity of 16,000 cps at 23° C. as measured according to the procedure described in U.S. Pat. No. 5,922,809 at column 12, lines 38 to 49;
(B) 1.2-2.0 wt % of a polyester prepolymer made by reacting a copolyester of molecular weight of 3,500 Da with MDI, preferably the polyester prepolymer has a melting point of 40-90° C.;
(C) 0.4 to 1.2 wt % aliphatic polyisocyanate that is an HDI trimer having an NCO content of 21.8±0.3% (according to DIN EN ISO 11 909); (D) 0.4 to 1.2 wt % aromatic polyisocyanate which is polymethylene polyphenylisocyanate that contains MDI, having an NCO content of 30.4% (according to DIN EN ISO 11 909);
(E) 0.4-1.5 wt % functionalised silane which is a reaction product of N,N-bis[(3-trimethoxysilyl)-propyl]amine) reacted with HDI-Biuret, having an isocyanate content of 7%;
(F) 0.5-0.99 wt % of amine catalyst which is 2,2′-dimorpholinodiethyl ether;
(G) gamma-mercaptopropyltrimethoxysilane at <1.2 wt %, and/or (G′) bis(gamma-trimethoxysilylpropyl)amine at <0.5 wt %, wherein the combination of amino and/or mercaptosilane is at least 0.6 wt %; (H) 17 to 20 wt % carbon black;
(I) 3-30 wt % calcium carbonate;
(J) optionally 0-27 wt % clay;
wherein the total polyisocyanate content is 1.2 to 3 wt %, the total of calcium carbonate plus clay is 20-30 wt %, and the weight percentages are based on the total weight of the polyurethane adhesive.
An adhesive composition comprising:
(A) 50-57 wt % of a polyether prepolymer, based on the total weight of the adhesive composition, comprising a nominally trifunctional poly(propylene oxide) having a hydroxyl number of 36 (equivalent weight 1558) and a nominally trifunctional poly(propylene oxide) having a hydroxyl number of 56 (equivalent weight 1000), and having an isocyanate content of 1.25% by weight, and a viscosity of 16,000 cps at 23° C. as measured according to the procedure described in U.S. Pat. No. 5,922,809 at column 12, lines 38 to 49;
(B) 1.2-2.0 wt % of a polyester prepolymer made by reacting a copolyester of molecular weight of 3,500 Da with MDI, preferably the polyester prepolymer has a melting point of 40-90° C.;
(C) 0.4 to 1.2 wt % aliphatic polyisocyanate that is an HDI trimer having an NCO content of 21.8±0.3% (according to DIN EN ISO 11 909); (D) 0.4 to 1.2 wt % aromatic polyisocyanate which is polymethylene polyphenylisocyanate that contains MDI, having an NCO content of 30.4% (according to DIN EN ISO 11 909);
(E) 0.4-1.5 wt % functionalised silane which is a reaction product of N,N-bis[(3-trimethoxysilyl)-propyl]amine) reacted with HDI-Biuret, having an isocyanate content of 7%;
(F) 0.5-0.99 wt % of amine catalyst which is 2,2′-dimorpholinodiethyl ether;
(G) gamma-mercaptopropyltrimethoxysilane at <1.2 wt %, and/or (G′) bis(gamma-trimethoxysilylpropyl)amine at <0.5 wt %, wherein the combination of amino and/or mercaptosilane is at least 0.6 wt %;
(H) 17 to 20 wt % carbon black;
(I) 3-30 wt % calcium carbonate;
(J) optionally 0-27 wt % clay;
wherein the total polyisocyanate content is 1.2 to 3 wt %, the total of calcium carbonate plus clay is 20-30 wt %, and the weight percentages are based on the total weight of the polyurethane adhesive.

An adhesive composition comprising:
(A) 52-54 wt % of a polyether prepolymer, based on the total weight of the adhesive composition, comprising a nominally trifunctional poly(propylene oxide) that is partially endcapped with ethylene oxide a nominally difunctional poly(propylene oxide), reacted with MDI, and having an isocyanate content of 1.25% by weight, and a viscosity of 16,000 cps at 23° C. as measured according to the procedure described in U.S. Pat. No. 5,922,809 at column 12, lines 38 to 49;
(B) 1.2-2.0 wt % of a polyester prepolymer made by reacting a copolyester of molecular weight of 3,500 Da with MDI, preferably the polyester prepolymer has a melting point of 60-70° C.;
(C) 0.5 to 1 wt % aliphatic polyisocyanate that is an HDI trimer having an NCO content of 21.8±0.3% (according to DIN EN ISO 11 909);
(D) 0.5 to 1 wt % aromatic polyisocyanate which is polymethylene polyphenylisocyanate that contains MDI, having an NCO content of 30.4% (according to DIN EN ISO 11 909);
(E) 0.8-1.0 wt % functionalised silane which is a reaction product of N,N-bis[(3-trimethoxysilyl)-propyl]amine) reacted with HDI-Biuret, having an isocyanate content of 7%;
(F) at or about 0.75 wt % of amine catalyst which is 2,2′-dimorpholinodiethyl ether;
(G) 0.93, 0.94 or 0.95 wt % of a mercaptosilane which is gamma-mercaptopropyltrimethoxysilane; (G′) at or about 0.11 wt % of an aminosilane which is bis(gamma-trimethoxysilylpropyl)amine;
(H) 17.6 to 18 wt % carbon black;
(I) 7 to 8 wt % calcium carbonate;
(J) 22 to 23 wt % clay;
wherein the total polyisocyanate content is 1.2 to 3 wt %, the total of calcium carbonate plus clay is 20-30 wt %, and the weight percentages are based on the total weight of the polyurethane adhesive.

Additional preferred embodiments are as follows:
1. A one-component polyurethane adhesive composition comprising:
   (A) at least one polyether prepolymer at a total content of polyether prepolymer of 50-57 wt %;
   (B) at least one polyester prepolymer at a total content of polyester prepolymer of 1.2-2.0 wt %;
   (C) at least one aliphatic polyisocyanate at a total aliphatic polyisocyanate content of 0.4-1.2 wt %;
   (D) at least one aromatic polyisocyanate at a total aromatic polyisocyanate content of 0.4-1.2 wt %;
   (E) at least one isocyanate functionalized silane at a total isocyanate functionalized silane content of 0.4-1.5 wt %;
   (F) amine catalyst at 0.50-0.99 wt %;
   (G) at least one mercaptosilane at a total mercaptosilane content of <1.2 wt % and/or (G′) at least one aminosilane at a total aminosilane content of <0.5 wt % wherein the combination of amino and/or mercaptosilane is at least 0.6 wt %;
   (H) carbon black at 17-20 wt %;
   (I) calcium carbonate at 3-30 wt %;
   (J) optionally filler, other than calcium carbonate and/or carbon black, at 0-27 wt %;
   wherein the total polyisocyanate content is 1.2 to 3 wt %, the total of calcium carbonate plus clay is 20-30 wt %, and the weight percentages are based on the total weight of the polyurethane adhesive.
2. The adhesive composition of embodiment 1, wherein the at least one polyether prepolymer (A) is selected from polymers made by polymerizing one or more polyether polyols in the presence of a polyisocyanate, preferable diisocyanate, and mixtures of such polyether prepolymers.
3. The adhesive composition of embodiment 1 or 2, wherein the polyether prepolymer (A) is a mixture of polyalkylene oxide diols and/or triols reacted with MDI.
4. The adhesive of embodiment 1, 2 or 3, wherein the at least one polyether prepolymer (A) is selected from polyether prepolymers made by polymerizing in the presence of at least one polyisocyanate at least one polyol selected from:
   (i) poly(alkylene oxide)diols, where the alkylene group is C₂ to C₄,
   (ii) trifunctional polyols resulting from poly(akylene oxide)diols reacted with a trifunctional polyol, where the alkylene group is C₂ to C₄;
   (iii) mixtures of (i), (ii) and (i) and (ii).
5. The adhesive of any one preceding embodiment, wherein the at least one polyether prepolymer (A) comprises a nominally trifunctional poly(propylene oxide) having a hydroxyl number of 36 (equivalent weight 1558) and a nominally trifunctional poly(propylene oxide) having a hydroxyl number of 56 (equivalent weight 1000), reacted with MDI.
6. The adhesive composition of any one preceding embodiment, wherein the at least one polyester prepolymer (B) is selected from polymers made by reacting one or more linear copolyesters with primary hydroxyl functionality with a polyisocyanate, preferably a diisocyanate, and mixtures of such polyester prepolymers.
7. The adhesive composition of any one preceding embodiment, wherein the at least one polyester prepolymer (B) is a reaction product of a copolyester of molecular weight of 3,500 Da with MDI, having a melting point of 40-90° C.
8. The adhesive composition of any one preceding embodiment, wherein the at least one aliphatic polyisocyanate (C) is selected from isophorone diisocyanate, 1,6-hexamethylene diisocyanate, bis(4-isocyanatocyclohexyl)methane, and trimethyl hexamethylene diisocyanate, any of which can be modified to include biuret, allophonate, urea, carbamate, isocyanurate or carbodiimide groups, and mixtures of these aliphatic polyisocyanates.
9. The adhesive composition of any one preceding embodiment, wherein the at least one aliphatic polyisocyanate (C) is HDI trimer having an NCO content of 21.8±0.3% (according to DIN EN ISO 11 909).
10. The adhesive composition of any one preceding embodiment, wherein the aromatic polyisocyanate (D) is selected from diphenylmethane diisocyanate (MDI), polymethylene polyphenylisocyanates, polymeric MDI (PMDI, a mixture of diphenylmethane diisocyanate and polymethylene polyphenylioscyanates), tetramethylxylene diisocyanate, toluene diisocyanate, any of which can be modified to include biuret, allophonate, urea, carbamate, isocyanurate or carbodiimide groups, and mixtures of these aromatic polyisocyanates.
11. The adhesive composition of any one preceding embodiment, wherein the aromatic polyisocyanate (D) is polymethylene polyphenylisocyanate that contains MDI, having an NCO content of 30.4% (according to DIN EN ISO 11 909).
12. The adhesive composition of any one preceding embodiment, wherein the isocyanate functionalized silane (E) is selected from reaction products of aminosilanes with polyisocyanates, reaction products of mercaptosilanes with polyisocyanates, others, and mixtures of these.
13. The adhesive composition of any one preceding embodiment, wherein the isocyanate functionalized silane (E) is a reaction product of a secondary aminoalkoxy silane and a polyisocyanate.
14. The adhesive composition of any one preceding embodiment, wherein the isocyanate functionalized silane (E) is a reaction product of N,N-bis[(3-trimethoxysilyl)-propyl]amine) reacted with HDI-Biuret.
15. The adhesive composition of any one preceding embodiment, wherein the amine catalyst (F) is selected from tertiary amines.
16. The adhesive composition of any one preceding embodiment, wherein the amine catalyst (F) is selected from N,N-dimethylcyclohexane, triethylenediamine, N,N,N,N-tetramethylalkylenediamine, N,N,N,N-pentamethyldiethylenetriamine, triethylamine, N,N-dimethylbenzylamine, N,N-dimethylhexadecylamine, N,N-dimethylbutylamine, 2,2′-and dimorpholinodiethyl ether.
17. The adhesive composition of any one preceding embodiment, wherein the amine catalyst (F) is 2,2′-and dimorpholinodiethyl ether.
18. The adhesive composition of any one preceding embodiment, wherein the at least one mercaptosilane (G) is selected from mercaptosilanes of the following formula:

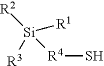

where R¹, R² and R³ are independently selected from OCH₃ and OC₂H₅; and R⁴ is CₙH₂ₙ where n is an integer of 1 to 12, and mixtures of such mercaptosilanes.
19. The adhesive composition of embodiment 18, wherein R¹, R² and R³ are OCH₃ and n is 1 to 6.
20. The adhesive composition of any one preceding embodiment, wherein the at least one mercaptosilane (G) is gamma-mercaptopropyltrimethoxysilane.
21. The adhesive composition of any one preceding embodiment, wherein the aminosilane (G′) is selected from aminosilanes of the following formula:

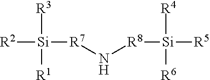

where R¹, R², R³, R⁴, R⁵ and R⁶ are independently selected from OCH₃ and OC₂H₅;
and R⁷ and R⁸ are independently selected from CₙH₂ₙ where n is an integer of 1 to 6, preferably n is 3, and mixtures of such aminosilanes.
22. The adhesive composition of any one preceding embodiment, wherein the aminosilane (G′) is bis(gamma-trimethoxysilylpropyl)amine.
23. The adhesive composition of any one preceding embodiment, wherein the filler (J) is a Kaolin clay.
24. The adhesive composition of any one preceding embodiment, wherein the at least one polyether prepolymer (A) is present at 52-54 wt %, based on the total weight of the adhesive composition.
25. The adhesive composition of any one preceding embodiment, wherein the at least one polyester prepolymer (B) is present at 1.3 to 1.5 wt %, based on the total weight of the adhesive composition.
26. The adhesive composition of any one preceding embodiment, wherein the at least one aliphatic polyisocyanate (C) is present at 0.5 to 1 wt %, based on the total weight of the adhesive composition.
27. The adhesive composition of any one preceding embodiment, wherein the at least one aromatic polyisocyanate (D) is present at 0.5 to 1 wt %, based on the total weight of the adhesive composition.
28. The adhesive composition of any one preceding embodiment, wherein the at least one isocyanate functionalized silane (E) is present at 0.8 to 1 wt %, based on the total weight of the adhesive composition.
29. The adhesive composition of any one preceding embodiment, wherein the amine catalyst (F) is present at 0.6 to 0.8 wt %, based on the total weight of the adhesive composition.
30. The adhesive composition of any one preceding embodiment, wherein the mercaptosilane (G) is present at 0.91 to 0.95 wt %, based on the total weight of the adhesive composition.
31. The adhesive composition of any one preceding embodiment, wherein the aminosilane (G′) is present at 0.05 to 0.22 wt %, based on the total weight of the adhesive composition.
32. The adhesive composition of any one preceding embodiment, wherein the carbon black (H) is present at 17.6 to 18 wt %, based on the total weight of the adhesive composition.
33. The adhesive composition of any one preceding embodiment, wherein the calcium carbonate (I) is present at 6 to 10 wt %, based on the total weight of the adhesive composition.
34. The adhesive composition of any one preceding embodiment, wherein the clay (J) is present at 21 to 24 wt % based on the total weight of the adhesive composition.
35. An adhesive composition according to any one preceding embodiment, having the following characteristics after 30 minutes curing:
   impact strength >3.4 J;
   Young's modulus >4 MPa;
   Lap shear strength on fritted glass >350 psi and >80% cohesive failure after 3 days at 23° C. and 50% RH;
   Preferably electrically resistivity of >1×10⁸ ohm*cm

### Examples

TABLE 1
Ingredients

| Trademark or | | |
|---|---|---|
| abbreviation | Chemistry | Function |
| VORANOL 220-056N | a nominally difunctional, | Ingredient in |
| POLYOL | poly(propylene oxide) | polyether |
| | having a hydroxyl number | prepolymer |
| | of 56 (equivalent weight | |
| | 1000) | |
| VORANOL 232-036N | a nominally trifunctional | Ingredient in |
| POLYOL | poly(propylene oxide) | polyether |
| | having a hydroxyl number | prepolymer |
| | of 36 (equivalent weight | |
| | 1558) that is partially | |
| | endcapped with ethylene | |
| | oxide | |
| MDI | 4,4′-Methylenebis(phenyl | Diisocyanate |
| | isocyanate) | |
| gamma- | gamma- | Mercaptosilane |
| mercaptopropyltrimeth- | mercaptopropyltrimeth- | (G) |
| oxysilane | oxysilane | |
| bis(gamma- | bis(gamma- | Amino silane |
| trimethoxysilyl- | trimethoxysilyl- | (G′) |
| propyl)amine | propyl)amine | |
| Elftex S7100 | carbon black | Carbon Black |
| | | Filler (H) |
| Clay | Kaolin clay (calcined | Clay Filler (J) |
| | aluminium silicate) | |
| Calcium | CaCO₃ | Calcium |
| carbonate | | Carbonate |
| | | Filler (I) |
| Diisononyl | Diisononyl phthalate | Plasticizer |
| phthalate | | |
| DOVERPHOS 4 | trisnonylphenyl phosphite | Stabilizer |
| TINUVIN 765 | Mixture of Bis(1,2,2,6,6- | Stabilizer |
| | pentamethyl-4- | |
| | piperidyl)sebecate and | |
| | methyl 1,2,2,6,6-penta- | |
| | methyl-4-piperidyl sebecate | |
| TINUVIN 571 | 2-(2H-benzotriazo-2-yl)-6- | Stabilizer |
| | dodecyl-4-methyl-Phenol | |
| DMDEE | 2,2′-dimorpholinodiethyl- | Amine catalyst |
| | ether | (F) |
| Desmodur N | Aliphatic polyisocyanate | Aliphatic |
| 3300 | based on HDI trimer, | polyisocyanate |
| | having an NCO content of | (C) |
| | 21.8 ± 0.3% (according to | |
| | DIN EN ISO 11 909) | |
| HDI | Hexamethylene | Aliphatic |
| | diisocyanate | polyisocyanate |
| PAPI 20 | A polymethylene | Aromatic |
| | polyphenylisocyanate that | polyisocyanate |
| | contains MDI, having an | (D) |
| | NCO content of 30.4% | |
| | (according to DIN EN ISO | |
| | 11 909) | |
| Desmodur | Aliphatic polyisocyanate | Ingredient in |
| N-100 | (HDI Biuret) used to make | isocyanate |
| | isocyanate functionalised | functionalised |
| | silane | silane |
| Fomrez UL-28 | dimethyltin dineodecanoate | Tin catalyst |
| KKAT 670 | Zinc carboxylate | Catalyst |

Polyether prepolymer (A): 363.68 g of Voranol 220-056 polyol, 527.04 g of Voranol 232-036 polyol and 32 g of diisononyl phthalate were charged into a 4-liter kettle, mixed and heated to 54° C. under nitrogen. All subsequent steps were performed under nitrogen. 160.64 g of molten MDI was added and mixed in. 0.08 g of stannous octoate catalyst was added drop wise. The temperature in the kettle rose due to the exothermic heat of reaction; the reaction mixture was maintained between 80° C. and 90° C. for 30 minutes. The reaction mixture was then cooled to 60° C. and 501.20 g of diisononyl phthalate and 15.36 g of diethyl malonate were added and mixed in for 30 minutes, followed by cooling to room temperature. The resulting polyalkylene prepolymer solution had an isocyanate content of 1.25% by weight and a viscosity of 16,000 cps at 23° C. as measured according to the procedure disclosed in U.S. Pat. No. 5,922,809 at column 12, lines 38 to 49.

Polyester prepolymer (B): was prepared as described in WO2017189057 in Example 5.

Isocyanate functionalised silane (E): A reaction product of a secondary aminoalkoxy silane and a polyisocyanate was prepared by adding 485 g of Desmodur N-100 (2.59 equivalents) (a solvent free aliphatic polyisocyanate resin based on hexamethylene diisocyanate-biuret), and 225 g of alkyl phthalate to a resin kettle equipped with a mechanical agitator, a thermometer, an N₂ inlet adapter and an addition funnel. The mixture was thoroughly mixed and purged under an N₂ blanket. About 300 g of N,N-bis[(3-trimethoxysilyl)-propyl]amine) (0.88 equivalents) was slowly added to the mixture. The adduct had an isocyanate content of 7.0 percent.

Preparation of Adhesive Compositions

Using the proportions listed in Table 2, calcium carbonate, clay, and Elftex S7100 were mixed and dried at 204° C. for about 20 hours and then cooled in a closed container to form a filler mixture. The polyester prepolymer was heated to 80° C. for about 15 h prior to use. The polyether prepolymer, DMDEE catalyst, aliphatic polyisocyanate, diisononyl phthalate, and isocyanate functionalized silane were charged into a 2-gallon mixer. The mixture was degassed and mixed under vacuum for 5 minutes. The vacuum was broken with nitrogen and then the mercaptosilane and aminosilane were added, followed by additional degassing and mixing under vacuum for 10 minutes.

The vacuum was broken again with nitrogen and then the filler mixture was added into the mixer. Mixing was started to wet out the fillers for 2 minutes. Vacuum was applied and mixing continued for 15 minutes. After breaking the vacuum with nitrogen, the mixture was scraped down and the polyester prepolymer was added along with any stabilizers. Mixing under vacuum was conducted for 10 minutes. The resulting adhesive composition was packaged into airtight tubes which were stored in nitrogen filled sealed aluminium bags.

Adhesive Testing Procedures

Round patties of adhesive were cured for 7 days at conditions of 23° C. and 50% relative humidity. Test coupons were cut from these cured sample patties and tested for Young's modulus according to ASTM D412 (Die C).

Glass coupons for primerless adhesion testing contain a press bent, bismuth based frit with a crystalline additive to aid in removing the glass from the mold.

Lap Shear Test

All lap shear samples were prepared according to SAE J1529 (May 1986) with the following exceptions: metal substrate was taped to the bottom side of the board and glass and/or metal to the top side, the urethane beads were measured post test to provide specific areas in strength calculations, and a maximum of three samples were prepared for each test. Glass was cleaned with a water and solvent glass cleaner (BETACLEAN™ 3300) and a sponge. E-coat was cleaned with Acetone. E-coat was primed with BETAPRIME™ 5504G or BETAPRIME™ Optimum, which are all-in-one polyisocyanate surface treatments and allowed to flash for 15 minutes. Beads of adhesive were applied, and the glass was decked. Samples were placed in 23° C./50% RH for three days, after which the samples were pulled right away for initial lap shear strength at a rate of 1 inch/minute (2.5 cm/min) with an Instron Tester. A group of at least 3 lap shear samples were tested and averaged. The load at break of the sample as well as modulus was recorded.

High Speed Impact Test

Impact resistance tests were carried out on an impact pendulum tester from TMI, type 43-01 at an impact speed of 4 m/s. The high-speed impact resistance and maximum strength were tested according to the following method. Samples were prepared by adhering approximately 1×1 inch pieces of fritted glass to the center of a 1×3 inch metal coupon. These were allowed to cure overnight. The glass samples were cleaned with the appropriate cleaners. An equal amount of 1×4 inch metal coupons were cleaned with Acetone. The 1×4 metal coupons were primed with the appropriate body primers. The primers were allowed to flash. The glass was inserted into specially designed fixtures that give a 1×1×0.25 inch block of urethane. The appropriate urethane was applied to the glass, and the appropriately primed 1×4 metal coupon was affixed perpendicular to and centered on the glass. After that the test specimens were stored for the desired cure time and environmental conditions. Then, the impact pendulum was brought up and latched, the test specimen fixed in position and the hammer released. For each test Impact resistance after 30 min at 23° C. and 50% RH is reported in KJoules.

Electrical Resistivity

The resistivity of samples of adhesive was measured with an HP 4339B High Resistance Meter and all formulations had values >1×10⁸ ohm*cm.

TABLE 2
Compositions of inventive and comparative examples (wt %, based on total weight of the adhesive)

| Ingredient | | | | | | | | | | | | | | |
|---|---|---|---|---|---|---|---|---|---|---|---|---|---|---|
| (wt %) | E1 | E2 | E3 | E4 | E5 | CE1 | CE2 | CE3 | CE4 | CE5 | CE6 | CE7 | CE8 | CE9 |
| Polyether | 53.5 | 53.2 | 53.3 | 53 | 52.64 | 54.55 | 54.55 | 54.55 | 54.01 | 53.72 | 54 | 55 | 54.05 | 54.05 |
| prepolymer (A) | | | | | | | | | | | | | | |
| Polyester | 1.3 | 1.3 | 1.35 | 1.50 | 1.48 | 1.17 | 1.17 | 1.17 | 1.16 | 1.15 | 1.5 | 1.5 | 1.5 | 1.5 |
| prepolymer (B) | | | | | | | | | | | | | | |
| Amine | 0.75 | 0.75 | 0.75 | 0.8 | 0.75 | 0.49 | 0.49 | 0.35 | 0.49 | 0.48 | 0.48 | 0.48 | 0.48 | 0.43 |
| catalyst (F) | | | | | | | | | | | | | | |
| Tin catalyst | | | | | | | | 0.02 | | | | | | 0.015 |
| KKAT 670 | | | | | | | | | | | 0.05 | | | 0.3 |
| Aliphatic | 0.5 | 0.8 | 0.99 | 0.99 | 0.96 | 1.17 | 1.17 | 1 | 1.16 | 1.15 | 1.15 | 0.47 | 0.47 | 0.47 |
| polyiso- | | | | | | | | | | | | | | |
| cyanate (C) | | | | | | | | | | | | | | |
| Aromatic | 0.75 | 0.75 | 0.75 | 0.75 | 0.74 | 0 | 0 | 1 | 0 | 0.49 | 0.49 | 0.2 | 0.5 | 0.5 |
| polyiso- | | | | | | | | | | | | | | |
| cyanate (D) | | | | | | | | | | | | | | |
| Isocyanate | 0.9 | 0.9 | 0.9 | 0.9 | 0.89 | 0 | 0 | 0 | 0.99 | 0.98 | 0.98 | 0.5 | 0.9 | 0.9 |
| functionalised | | | | | | | | | | | | | | |
| silane (E) | | | | | | | | | | | | | | |
| Mercapto- | 0.94 | 0.94 | 0.94 | 0.95 | 0.93 | 0.97 | 0.97 | 0.97 | 0.96 | 0.96 | 0.95 | 0.94 | 0.94 | 0.94 |
| silane (G) | | | | | | | | | | | | | | |
| Aminosilane | 0.11 | 0.11 | 0.11 | 0.11 | 0.11 | 0.11 | 0.11 | 0.11 | 0.11 | 0.11 | 0.11 | 0.11 | 0.11 | 0.11 |
| (G') | | | | | | | | | | | | | | |
| Carbon | 17.82 | 17.82 | 17.82 | 17.8 | 17.64 | 17.55 | 17.55 | 16.59 | 17.37 | 17.28 | 17.25 | 17.21 | 17.21 | 17.21 |
| black (H) | | | | | | | | | | | | | | |
| Clay (J) | 15.10 | 15.16 | 15.10 | 15 | 14.95 | 23.4 | 15 | 15 | 14.85 | 14.77 | 14.4 | 14.71 | 14.71 | 14.71 |
| Calcium | 7.86 | 7.8 | 7.49 | 7.2 | 7.42 | 0 | 8.4 | 8.4 | 8.32 | 8.27 | 8 | 8.24 | 8.24 | 8.24 |
| carbonate (I) | | | | | | | | | | | | | | |
| Plasticizer | 0.47 | 0.47 | 0.5 | 1 | 1.49 | 0.59 | 0.59 | 0.59 | 0.58 | 0.64 | 0.64 | 0.64 | 0.64 | 0.38 |
| Stabilizer | | | | | | | | 0.25 | | | | | 0.25 | 0.25 |
| Small molecule | 2.15 | 2.45 | 2.64 | 2.64 | 2.59 | 1.17 | 1.17 | 2 | 2.15 | 2.62 | 2.62 | 1.17 | 1.87 | 1.87 |
| NCO | | | | | | | | | | | | | | |
| Polyisocyanate | 1.25 | 1.55 | 1.74 | 1.74 | 1.70 | 1.17 | 1.17 | 2 | 1.16 | 1.64 | 1.64 | 0.67 | 0.97 | 0.97 |
| Calcium | 7.86 | 7.8 | 7.49 | 7.2 | 7.42 | 0 | 8.4 | 8.4 | 8.32 | 8.27 | 8 | 8.24 | 8.24 | 8.24 |
| carbonate | | | | | | | | | | | | | | |
| Clay + calcium | 22.96 | 22.96 | 22.59 | 22.2 | 22.37 | 23.4 | 23.4 | 23.4 | 23.17 | 23.04 | 22.4 | 22.95 | 22.95 | 22.95 |
| carbonate | | | | | | | | | | | | | | |
| solids | 40.78 | 40.78 | 40.41 | 40 | 40.01 | 40.95 | 40.95 | 39.99 | 40.54 | 40.32 | 39.65 | 40.16 | 40.16 | 40.16 |

TABLE 3
Lap shear strength and failure mode for Examples
of the invention and Comparative Examples

| Example/Comparative | Lap shear | % Cohesive |
|---|---|---|
| Example | strength (psi) | failure |
| E1 | 455 | 94 |
| E2 | 368 | 100 |
| E3 | 503 | 100 |
| E4 | 585 | 80 |
| E5 | 357 | 100 |
| CE1 | 121 | 32 |
| CE2 | 263 | 100 |
| CE3 | 205 | 40 |
| CE4 | 187 | 100 |

TABLE 4
Lap shear modulus and Young’s modulus for Examples
of the invention and Comparative Examples

| Example/Comparative | Lap shear | Young′s |
|---|---|---|
| Example | modulus (MPa) | modulus |
| E1 | 1.21 | 4.08 |
| E2 | 1.54 | 6.07 |
| E3 | 1.39 | 5.81 |
| E4 | 1.43 | 4.88 |
| E5 | 1.35 | 5.08 |
| CE1 | 0.98 | — |
| CE8 | 1.17 | — |

TABLE 5
High-speed impact energy after 30 minutes for Examples
of the invention and Comparative Examples

| Example/Comparative | High-speed impact |
|---|---|
| Example | energy (KJ) |
| E1 | 4.4 |
| E2 | 3.9 |
| E3 | 3.7 |
| E4 | 4.2 |
| E5 | 3.9 |
| CE2 | 3.3 |
| CE5 | 2.9 |
| CE6 | 3.3 |
| CE8 | 3.1 |
| CE9 | 3.0 |

The above Tables show results for five inventive formulations and nine comparative formulations. In order to meet the requirements of automotive manufacturers and to have a safe drive away time of 30 minutes, the adhesives should have the following characteristics:
impact strength after 30 minutes >3.4 J;
Young's modulus >4 MPa;
Lap shear strength on frit >350 psi and >80% cohesive failure after 3 days at 23° C. and 50% RH;
Preferably electrically resistivity of >1×10⁸ ohm*cm

The performance of the comparative adhesives is lacking in at least one of the desired performance characteristics: lap shear strength (i.e. primer-less adhesion), lap shear modulus, or impact strength after 30 minutes (safe drive away time).

1. A one-component polyurethane adhesive composition comprising:
(A) at least one polyether prepolymer at a total content of polyether prepolymer of 50-57 wt %;
(B) at least one polyester prepolymer at a total content of polyester prepolymer of 1.2-2.0 wt %;
(C) at least one aliphatic polyisocyanate at a total aliphatic polyisocyanate content of 0.4-1.2 wt %;
(D) at least one aromatic polyisocyanate at a total aromatic polyisocyanate content of 0.4-1.2 wt %;
(E) at least one isocyanate functionalized silane at a total isocyanate functionalized silane content of 0.4-1.5 wt %;
(F) amine catalyst at 0.50-0.99 wt %;
(G) at least one mercaptosilane at a total mercaptosilane content of <1.2 wt % and/or (G′) at least one aminosilane at a total aminosilane content of <0.5 wt % wherein the combination of amino and/or mercaptosilane is at least 0.6 wt %;
(H) carbon black at 17-20 wt %;
(I) calcium carbonate at 3-30 wt %;
(J) optionally filler, other than calcium carbonate and/or carbon black, at 0-27 wt %;
wherein the total polyisocyanate content is 1.2 to 3 wt %, the total of calcium carbonate plus clay is 20-30 wt %, and the weight percentages are based on the total weight of the polyurethane adhesive.

2. The adhesive composition of claim 1, wherein the at least one polyether prepolymer (A) is selected from polymers made by polymerizing one or more polyether polyols in the presence of a polyisocyanate, preferable diisocyanate, and mixtures of such polyether prepolymers.

3. The adhesive composition of claim 1, wherein the polyether prepolymer (A) is a mixture of polyalkylene oxide diols and/or triols reacted with MDI.

4. The adhesive of claim 1, wherein the at least one polyether prepolymer (A) is selected from polyether prepolymers made by polymerizing in the presence of at least one polyisocyanate at least one polyol selected from:
(i) poly(alkylene oxide)diols, where the alkylene group is C₂ to C₄,
(ii) trifunctional polyols resulting from poly(akylene oxide)diols reacted with a trifunctional polyol, where the alkylene group is C₂ to C₄;
(iii) mixtures of (i), (ii) and (i) and (ii).

5. The adhesive of claim 1, wherein the at least one polyether prepolymer (A) comprises a nominally trifunctional poly(propylene oxide) having a hydroxyl number of 36 (equivalent weight 1558) and a nominally trifunctional poly(propylene oxide) having a hydroxyl number of 56 (equivalent weight 1000), reacted with MDI.

6. The adhesive composition of claim 1, wherein the at least one polyester prepolymer (B) is selected from polymers made by reacting one or more linear copolyesters with primary hydroxyl functionality with a polyisocyanate, preferably a diisocyanate, and mixtures of such polyester prepolymers.

7. The adhesive composition of claim 1, wherein the at least one polyester prepolymer (B) is a reaction product of a copolyester of molecular weight of 3,500 Da with MDI, having a melting point of 40-90° C.

8. The adhesive composition of claim 1, the at least one aliphatic polyisocyanate (C) is selected from isophorone diisocyanate, 1,6-hexamethylene diisocyanate, bis(4-isocyanatocyclohexyl)methane, and trimethyl hexamethylene diisocyanate, any of which can be modified to include biuret, allophonate, urea, carbamate, isocyanurate or carbodiimide groups, and mixtures of these aliphatic polyisocyanates.

9. The adhesive composition of claim 1, wherein the at least one aliphatic polyisocyanate (C) is HDI trimer having an NCO content of 21.8±0.3% (according to DIN EN ISO 11 909).

10. The adhesive composition of claim 1, wherein the aromatic polyisocyanate (D) is selected from diphenylmethane diisocyanate (MDI), polymethylene polyphenylisocyanates, polymeric MDI (PMDI, a mixture of diphenylmethane diisocyanate and polymethylene polyphenylioscyanates), tetramethylxylene diisocyanate, toluene diisocyanate, any of which can be modified to include biuret, allophonate, urea, carbamate, isocyanurate or carbodiimide groups, and mixtures of these aromatic polyisocyanates.

11. The adhesive composition of claim 1, wherein the aromatic polyisocyanate (D) is polymethylene polyphenylisocyanate that contains MDI, having an NCO content of 30.4% (according to DIN EN ISO 11 909).

12. The adhesive composition of claim 1, wherein the isocyanate functionalized silane (E) is selected from reaction products of aminosilanes with polyisocyanates, reaction products of mercaptosilanes with polyisocyanates, others, and mixtures of these.

13. The adhesive composition of claim 1, wherein the isocyanate functionalized silane (E) is a reaction product of a secondary aminoalkoxy silane and a polyisocyanate.

14. The adhesive composition of claim 1, wherein the isocyanate functionalized silane (E) is a reaction product of N,N-bis[(3-trimethoxysilyl)-propyl]amine) reacted with HDI-Biuret.

15. The adhesive composition of claim 1, wherein the amine catalyst (F) is selected from tertiary amines.

16. The adhesive composition of claim 1, wherein the amine catalyst (F) is selected from N,N-dimethylcyclohexane, triethylenediamine, N,N,N,N-tetramethylalkylenediamine, N,N,N,N-pentamethyldiethylenetriamine, triethylamine, N,N-dimethylbenzylamine, N,N-dimethylhexadecylamine, N,N-dimethylbutylamine, 2,2′-and dimorpholinodiethyl ether.

17. The adhesive composition of claim 1, wherein the amine catalyst (F) is 2,2′-and dimorpholinodiethyl ether.

18. The adhesive composition of claim 1, wherein the at least one mercaptosilane (G) is selected from mercaptosilanes of the following formula: 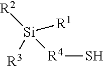
where R¹, R² and R³ are independently selected from OCH₃ and OC₂H₅;
and R⁴ is CₙH₂ₙ where n is an integer of 1 to 12, and mixtures of such mercaptosilanes.

19. The adhesive composition of claim 18, wherein R¹, R² and R³ are OCH₃ and n is 1 to 6.

20. The adhesive composition of claim 1, wherein the at least one mercaptosilane (G) is gamma-mercaptopropyltrimethoxysilane.

21-34. (canceled)
